(19) United States
(12) Patent Application Publication
(10) Pub. No.: US 2005/0230563 A1
(43) Pub. Date: Oct. 20, 2005

(54) Automatic formation flight control system

(76) Inventor: James J. Corcoran III, Scottsdale, AZ (US)

Correspondence Address: JAMES J. CORCORAN, III, 12258 NORTH 120TH STREET, SCOTTSDALE, AZ, 85259, US

(21) Appl. No.: 10/894,393

(22) Filed: Jul. 19, 2004

Related U.S. Application Data
(63) Continuation-in-part of application No. 10/784,660, filed on Feb. 21, 2004, now Pat. No. 6,926,233.

(51) Int. Cl. B64C 13/18

(52) U.S. Cl. 244/175

(57) ABSTRACT

An integrated system for automatic formation flight control of multiple vehicles such as aircraft, helicopters, or space platforms. The system is used to control multiple aircraft in a pre-determined flight formation and provide positive identification, control and discrete communications between any number of aircraft in order to prevent mid-air collisions between aircraft in formation flight. The system includes a processor located on the aircraft to enable communications, position computations and control messaging between any number of aircraft in formation flight, a communications transceiver located on the aircraft that provides discrete communication links to any number of aircraft or aircraft in formation flight, an autopilot, an autothrottle and a display. On aircraft, the system will display the current formation and aircraft relative positions under control by the system. The system may also be used to circumvent control of a hijacked aircraft through control system intervention provided through this invention.

### CROSS REFERENCE TO RELATED APPLICATIONS

This application is related to pending application Ser. No. 10/784660, filed Feb. 21, 2004, herein incorporated by reference.

### BACKGROUND OF THE INVENTION

This invention relates generally to the field of transportation and more specifically to a system for automatic formation control of aircraft. Particular utility exists in the automatic formation of flights of aircraft of any type and specifically not restricted to or not limited to commercial or military aircraft, helicopters, unmanned aircraft, missiles, or space platforms. It may also be used to enable automated air traffic control and to provide control of hijacked aircraft from the ground or another aircraft with similar equipment.

Formation flight has always been the cornerstone of both precision flight and mission execution. In tight formation flight, a single radar image is displayed on a radar screen. Presenting one radar image, size or surprise is a key to military success. As the regimes of speed have increased, the requirement for a more positive control of close and tight formation has been a request by mission planners and pilots. Technology has now progressed to a point where the integration of various functions can be accomplished without significant hardware. Recent, increased computing power allows for software to execute the required controls to include position, clearance and flight planning more efficiently and quickly than under manual control. The global positioning satellite constellation and the significant lack of positional and navigation error in military operations opens the door for automatic formation flight configuration totally integrated system.

Voice communications, eyesight contact, pilot intervention and limited radar capability has been the method of control for formation flight for many years. It required the pilot to talk with another pilot to determine position, direction, speed and altitude. Delay in communications, interpretation of instruments and man-machine interface placed the formation in peril.

Weather, turbulence and speed have contributed to accidents even under the best of circumstances. Due to equipment restrictions and the need for visual contact or radar surveillance, positive control was difficult if not impossible.

Delays inherent in voice communications coupled with reaction times have prevented a precise execution of formation flight up to now. The advent of high-speed data communications, man/machine interface improvements and positive flight control capabilities, now allows for a totally integrated automatic flight formation control system.

### BRIEF SUMMARY OF THE INVENTION

One advantage of the invention is to provide discrete, precise, positive control of aircraft flying in formation flight.

Another advantage of the invention is to provide discrete navigational, positional and performance control to aircraft in formation flight.

A further advantage of the invention is to provide discrete ‘look-ahead’ computation for each aircraft in formation flight. Air turbulence, winds aloft acting on the formation can be calculated quickly to permit corrections before the condition affects the formation or individual aircraft. This information can be shared quickly with each aircraft in the formation.

Yet another advantage of this invention is that it provides discrete formation displays for cockpit reference for any number of aircraft in formation flight.

A significant additional advantage is to provide a technical basis through discrete aircraft identification to guide aircraft through an air traffic control system by broadcasting flight directions electronically to the cockpit and having the aircraft react to those instructions. This would also allow another aircraft or ground control to take control of the aircraft in the event of a highjacking or other form of incapacitation of the flight crew.

Other advantages and objects of the present invention will become apparent from the following descriptions, taken in conjunction with the accompanying drawings, wherein, by way of illustration and example, an embodiment of the present invention is disclosed.

In accordance with a preferred embodiment of the invention, there is disclosed; a totally integrated system for automatic formation flight control of multiple aircraft such as but not limited to aircraft, helicopters, or space platforms. The system comprises an automatic flight control system with a processor located on each aircraft to enable communications and control to any number of aircraft in formation flight. A communications transceiver is located aboard each aircraft to provide a discrete communication link to any number of aircraft in formation flight. An aircraft communications bus protocol and message packet structure is provided to enable the exchange of information between multiple aircraft in formation flight. Encrypted communication between aircraft further enhances the security of the mission. Central to the formation flight control system is a method of providing a computed “formation zone” (FZ) that provides elemental positional information for multiple aircraft in formation flight within the FZ. The formation zone may be an envelope, such as a box, sphere or other defined cubic space whose volume is calculated to represent the defined area of the “formation zone.” A process for selecting both formation flight pattern and spatial clearance between multiple aircraft in formation flight is carried out before and during the mission where one might change the flight profile based on enroute flight conditions. The method or process comprises the acts of: a) providing “real-time” display of aircraft and positions of multiple aircraft in formation flight on the display on each aircraft or part of C4I control station architecture; b) providing a “buffer zone” with a “relative formation point” (RFP) for each aircraft in formation flight; c) continuously polling each aircraft in formation flight for positional information; d) providing flight guidance to each individual aircraft including autopilot inputs to each of multiple aircraft in formation flight and; e) providing “dampening” of the flight profile to multiple aircraft in formation flight. These acts of the disclosed method are the basis for a totally integrated system to provide control of aircraft in formation flight, when used in conjunction with an autopilot located on each vehicle capable of receiving and transmitting inputs/outputs from the aircraft's communications bus. These communications represent the data packets from each aircraft and are handled by the transceiver located on each aircraft and placed on the communication bus for processing and action if required.

In accordance with a preferred embodiment of the invention, there is disclosed a process for automatic formation flight control of vehicles. The type of vehicle is not limited to aircraft, helicopters, or space platforms but may include although not limited to ships, submarines, ground vehicles, self-guided and remotely guided surface, subsurface and airborne equipment. Control of the formation, herein an example being an aircraft, comprises the acts of: a control system with processor located on each aircraft, the processor enabling communications and control to each aircraft in formation flight and calculate the formation zone and relative formation point and initiate exchange of similar information between multiple aircraft in order to prevent mid-air collision of multiple aircraft under system control. As stated above, a communications transceiver located on each aircraft provides discrete communication links to others of the aircraft in formation flight. An aircraft communications bus protocol and message packet structure provides exchange of information from and to each of the multiple aircraft in formation flight. Such communications are encrypted for security. Core to the formation flight control system is a method of providing a computed “formation zone” (FZ) that provides elemental positional information for multiple aircraft in formation flight. Such FZ incorporates indicated airspeed (IAS), position (latitude and longitude provided by global positioning system (GPS)), altitude provided by radio altimeter correlated with pressure altimeter plus predetermined distance from wing tip of each formation aircraft and a “buffer zone” with the relative formation point (RFP). The RFP is calculated for and comprises a composite cubic area of the four corners of the FZ and the center point of the FZ. The capability of selecting a formation flight pattern, such as patterns known as “loose deuce”, “finger four”, “echelon right”, “echelon left”, “line abreast”, “flying “V”, “diamond four”, “arrowhead four”, “five of diamonds”, “delta” and “line astern” is provided by mission control prior to and during the mission. The formation flight control system also provides spatial clearance between multiple number of aircraft in formation flight. In each aircraft a “real-time” display of each aircraft and positions of each aircraft in formation flight is available. The processor on each aircraft calculates the “buffer zone” with a RFP for each aircraft in formation flight. Information is shared between all aircraft in formation flight for positional data through the communication packets. Flight guidance is provided to each aircraft based on the calculations performed by an “off-aircraft” central processing station or by a lead central processing station on a selected lead aircraft in the formation, and communications including autopilot inputs to each of the aircraft in formation flight. Look ahead algorithms provide “dampening” of the flight profile to multiple aircraft in formation flight. Continuous review and interpretation of in-flight conditions and the transfer of this information via data packets provide corrections to separations based upon these in-flight conditions. These assist in the smooth execution of the mission profile. This totally integrated system provides control of any number of aircraft in formation flight. Each aircraft is equipped with an autopilot capable of receiving inputs from the vehicle communications bus and the communication data packets.

### BRIEF DESCRIPTION OF THE DRAWINGS

The drawings constitute a part of this specification and include an exemplary embodiment of the invention, which may be embodied in various forms.

FIG. 1 is a block diagram setting forth the various parts of the Automatic Formation Flight Control System (AFFCS) and the integration of the processes used in implementing the system.

FIG. 2 is a pictorial, schematic representation of the Formation Zone and the Relative Formation Point.

FIG. 3 is a flow chart diagram illustrating the function of initiating the formation flight control system.

FIG. 4 is a pictorial, schematic representation of the Hijacking Intervention/Interdiction Function performed utilizing AFFCS.

### DETAILED DESCRIPTION OF THE PREFERRED EMBODIMENT

A detailed description of the preferred embodiment is provided herein. It is to be understood, however, that the present invention may be embodied in various forms. Therefore, specific details disclosed herein are not to be interpreted as limiting, but rather as a basis for the claims and as a representative basis for teaching one skilled in the art how to employ the present invention in an appropriately detailed system, structure or manner.

### DETAILED DESCRIPTION OF THE INVENTION

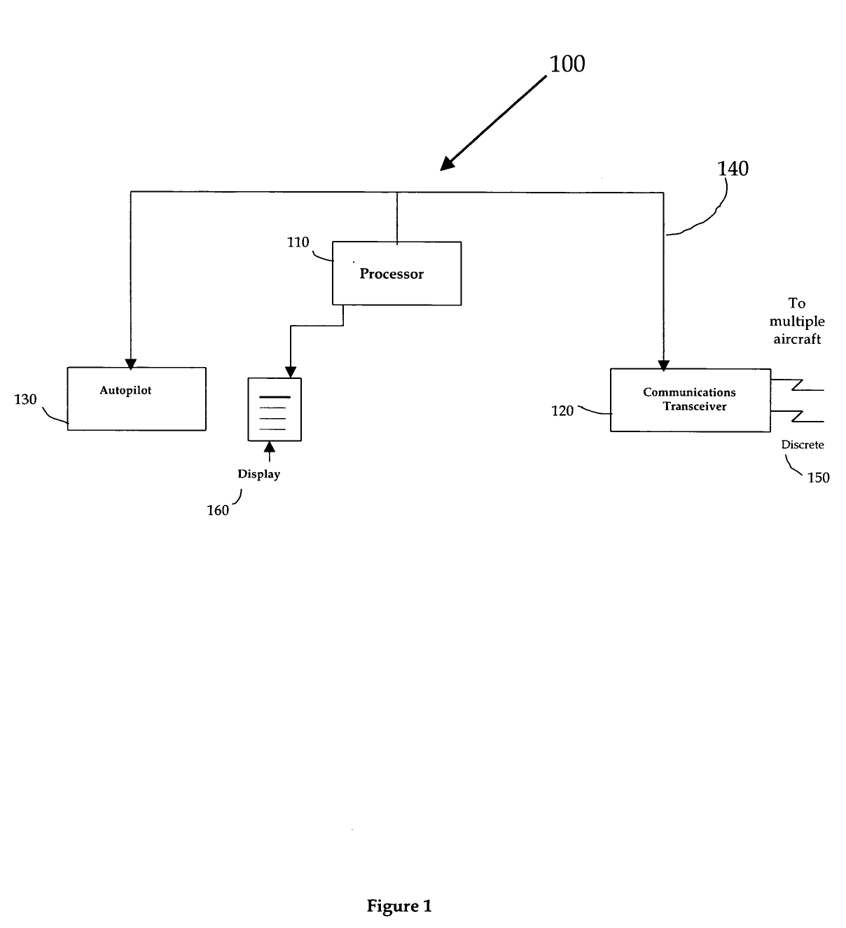

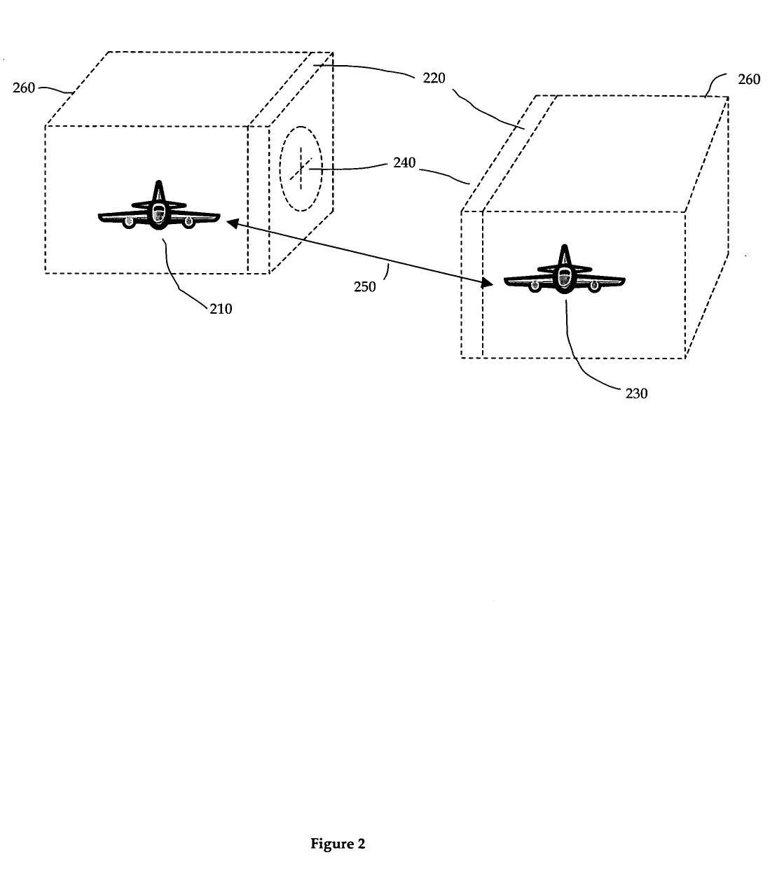

The present invention provides a system, a method and a process for automatic formation flight control for use in either commercial or military flight applications of fixed wing aircraft, helicopters, space vehicles or the like. The system is used to avoid mid-air collisions during formation flight and provide guidance to aircraft requiring close maneuvering in flight regimes, orbital flight and maneuvering as part of some of the exemplary embodiments. It also may be utilized to provide intervention or interdiction of a hijacked aircraft by either another aircraft equipped with AFFCS or a ground control station. For instance, as illustrated in FIG. 2, the system may be used to initiate automatic formation flight control by aircraft 210 that this aircraft 210 has entered the correct formation selection, identify friend or foe (IFF) code and password to initiate communications with second aircraft 230 on which resides, as illustrated in FIG. 1, processor 110, communications transceiver 120 and autopilot 130 with an aircraft communications bus 140.

As illustrated in FIG. 1, the system generally includes a control processing unit or processor 110, a communications transceiver 120, an autopilot 130 and a communications bus 140, all of which are located on the aircraft (e.g. on aircraft 210 and 230 in FIG.2). Thus the exemplary embodiment illustrated in FIG. 1 might include aircraft automatic flight control system, generally 100 plus formation flight control systems in other aircraft in a formation of multiple aircraft each with the same capability of being the “lead” system or utilizing the system as the controlled aircraft.

As an overview, automatic formation flight control system processor 110 on one aircraft, here the “lead” system, initiates the formation communications with the other aircraft in the formation and repeatedly interrogates the other aircraft automatic flight control systems as to the position in the formation zone 260 as illustrated in FIG. 2 with a computation of relative formation point 240 as illustrated in FIG. 2. The RFP is a computed point derived from an algorithm taking into the computation aircraft type; airspeed; indicated airspeed; latitude and longitude determined by a global positioning system calculations; altimeter data; look ahead calculations to include turbulence and winds aloft at the current altitude and wingtip clearance selection 250; as illustrated in FIG. 2.

The system includes an automatic reversion function if the lead aircraft of the formation is lost due to an interfering event. The loss of a mission leader will be provided for through a succession protocol that transfers “lead” responsibilities to the next aircraft in the particular formation as designated by the formation pattern or mission profile. Formation flight control is now assumed by the new “lead” aircraft and each aircraft is notified of the change and the displays are updated to indicate this event.

Although the invention is discussed in terms of a flight control system for fixed wing aircraft, an automatic formation flight control system according to the present invention may be a system installed on an aircraft, or may include the aircraft itself or other aircraft. In any case, the present invention may require additional hardware if all parts for participation in this system are not present on the aircraft, e.g. IFF transponder, or may be constructed, all or in part, using hardware already installed on the aircraft, e.g. for other purposes. In some embodiments, such as illustrated in FIG. 2, the formation is a flight of two aircraft (e.g. 210 and 230). However, the aircraft may be another type of vehicle such as a helicopter or a space vehicle or platform. As referenced earlier it may include, ships, submarines, ground vehicles, self guided and remotely guided surface and subsurface and airborne equipment. In addition, in other embodiments, the vehicle may be a orbiting space platform in which there is a landing or docking zone that requires a synchronizing of flight paths to match velocity, position and axial movement, a group of unmanned remote piloted vehicles, or generally any other vehicle configured to move in a controlled formation. Significantly, it might comprise the utilization of an automatic flight control system by a ground or satellite based air traffic control system to control commercial air traffic. Through the use of existing cockpit datalink communication technology and distinct aircraft identification, air traffic may control the movement of individual aircraft in the air traffic system. Further, any aircraft or ground based control center would be able to control the flight of an aircraft that may have been hijacked thereby overriding the cockpit controls and eliminating the threat to people and property.

Referring to FIG. 2, a formation selection of a “flight of two,” results in the leader 210 initiating the formation with the appropriate identification friend or foe code along with the password for this mission with the wingman 230 and the associated system on that aircraft. Upon receiving the correct acknowledgment through the transaction process initiation of formation request, the automatic formation flight control system begins to poll the other aircraft for the data required such as the 260 formation zone calculations and the 220 relative formation point as illustrated in FIG. 2 in addition to the display of the formation on the display as part of the processor system 110 as illustrated in FIG. 1. Aircraft type, course, speed, altitude, turbulence and look ahead flight plan corrections are then shared with all aircraft in the formation through the data packets and sent to the respective autopilot and autothrottle of each aircraft required to make corrections to alter the course to prevent a mid-air collision. Any navigational procedures can be utilized as part of the system to control a mission profile (e.g. a joint bombing run on a target). Although described herein as being separate systems or components, as would be understood by a person skilled in the art, conceptual components described herein of these and other systems may be combined in the same equipment or may be part of other systems or equipment unrelated to the present invention.

A formation zone 260 as illustrated in FIG. 2 is generally an area of spatial interest, which locates a vehicle controlled by an automatic formation flight control system. It may be comprised of the computed relative formation point closest to next aircraft, a computed volume or protected formation zone around the aircraft and may also be comprised of a box, sphere or envelope.

The data would include position as determined by a global positioning system location, true airspeed, indicated airspeed, altitude, radar altimeter, instantaneous vertical speed indicator, wingtip clearance selection, look ahead trending (turbulence, winds aloft and/or weather) and the creation of an envelope of any shape, with a preferred shape being a six sided box or sphere around the aircraft with calculated corners or volume and relative formation point 240 as illustrated in FIG. 2. Multiple relative formation points may be created as required by the formation selection, to include aircraft adjacent, in front of, behind, above or below the leader 210. This results in the creation of a spatial relationship between the aircraft and the ability then to display the formation under automatic formation flight control system control on the displays in each of the aircraft. In many embodiments, the formation zones 260 are particular calculated spatial areas relative to the other aircraft also calculated formation zones. However, the formation zone in accordance with the present invention may be defined relative to other references or coordinate systems as embodied by the calculation systems (processor 110) capable of providing information relative to those references or coordinate systems, or that can be converted to such information through algorithms and tables.

The processor system 110 is typically on board each of the aircraft that are participating in controlled formation flight and provides the input and output to the on board autopilot 130, the on board communications transceiver 120, the on board display 160 by message packet data delivery to other any number of aircraft under control of automatic formation flight control system. Processor 110 may be a computer processor, typically capable of performing operations and manipulating data.

As illustrated in FIG. 1, processor 110 receives information from various inputs such as GPS (Global Positioning System), IVSI (Instantaneous Vertical Speed Indicator), radar altimeter, IAS (Indicated Air Speed), TAS (True Air Speed), pressure altimeter, aircraft type selection, wingtip clearance selection, aircraft length selection, formation selection and calculates the FZ 260 and RFP 240 for each aircraft. The processor in the aircraft then creates a message packet to be sent to the other aircraft under AFFCS control so that each of the recipient aircraft, the controlled aircraft can monitor and update their individual displays, relative positions and clearance requirements. The processor 110 on the lead aircraft also receives message packets from the other aircraft and uses that data to determine the display parameters for display 160 and trend analysis for the entire flight formation. Processor 110 is configured to initiate, or provide controlling input to, the autopilot 130, the processor on aircraft under automatic formation flight control system control, and the occupants of the aircraft. Processor 110 may have other responsibilities or be part of another system such as, for example, a navigation computer, a control system, or a flight management system (FMS). The processor may also be off-board in the case of an air traffic control system embodiment. It may also be in a C4I platform such as an AWACS (Advanced Warning Airborne Control System) aircraft, ground or satellite based system, ship or other aircraft not involved with the control system.

For example, processor 110 may be programmed or configured to calculate the FZ 260 and the RFP 240 and initiate formation flight control to multiple aircraft participating through the unique IFF and mission password. The leader 210 as illustrated in FIG. 2 has the main authority for the formation and becomes the “lead” aircraft. Processor 110 may be programmed to continuously calculate spatial position and transmit this information via message packets with the other aircraft processors in a coordinated manner so as to avoid conflicts and mid-air collisions.

In the more complex embodiments, processor 1 10 may be configured to take into consideration the motion, relative position, membership in the flight, spatial trends as affected by winds aloft and weather and all other information. Processor 110 may then suggest adjustments in the formation profile and pass this information along to the other aircraft, the controlled aircraft, so that uniform formation clearance is maintained. The amount of adjustment, for instance, may be proportional, or otherwise related to, the aircraft type, the speed, position, altitude, FZ 260, buffer control zone 220 (which takes into account the wingtip clearance selection and trend analysis) and recommended to the lead aircraft via autopilot and autothrottle plus also statused to the other aircraft in the formation for update or action. Processor 110 may use color changes (e.g. from blue to yellow) to highlight a potential conflict in the formation flight in order to alert the pilot or pilots to a future possible inter-aircraft conflict. Processor 110 will recommend actions and immediately react to the trend if the processor determines that the possible conflict has the potential of creating a mid-air situation by directing the autopilot or autothrottle 130 to move the control surfaces in a manner that eliminates the conflict or increase or reduce speed via the autothrottles to place the vehicle in conformance with the overall formation. This action is typical throughout the entire embodiment of this invention.

Referring to the embodiment in FIG. 2, the automatic formation flight control system provides the means to reduce mid-air collisions during close formation flight regimes which at current speeds and maneuverability capabilities exceed the man/machine interface and require, especially in coordinated flight maneuvers (e.g. bombing missions), accurate control of the entire formation. This is especially critical in low visibility or night operations where the elements of stealth or surprise are important to the mission success.

In embodiments on aircraft, such as aircraft 210 in FIG. 2, existing systems on the aircraft may provide most of the hardware required for the integration of the AFFCS into the aircraft. For instance, the FMS (Flight Management System) may perform the processing, communications; positioning, input/output processing and the cockpit display unit may provide the visual display. In some embodiments only wiring and software changes may be required. For instance, a FZ, RFP and buffer zone algorithm may need to be loaded into the FMS and refined to work with existing control systems.

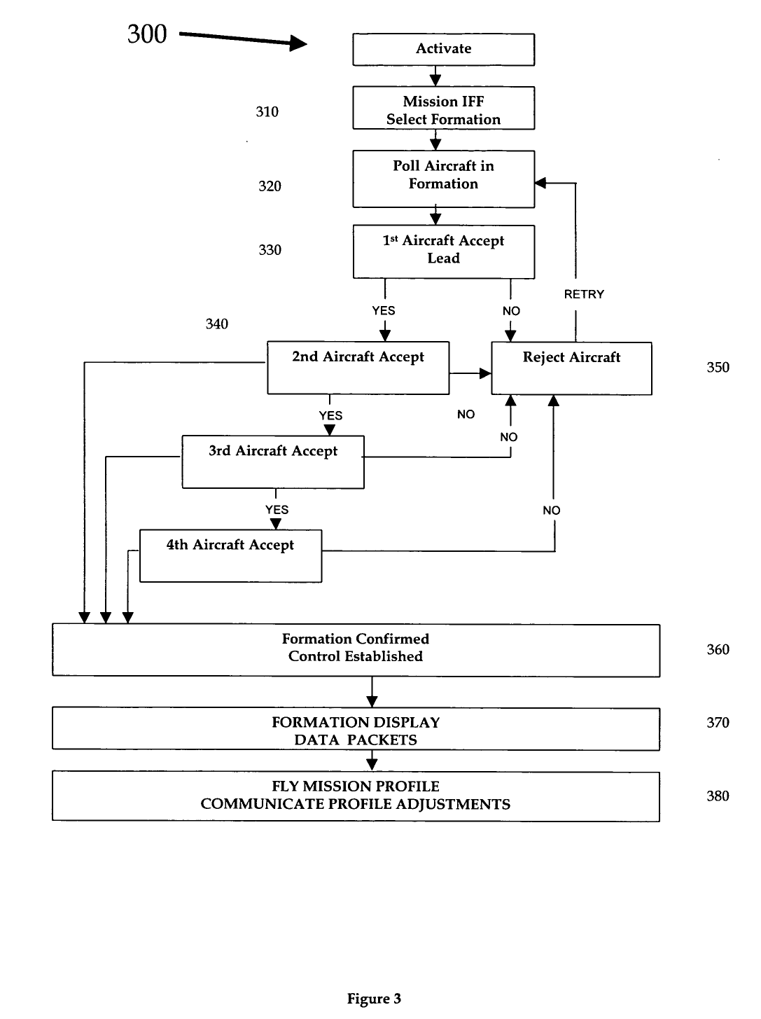

FIG. 3 illustrates a method for initiating automatic flight control of a formation according to the present invention. The lead aircraft is represented by 300. The method is one of many which is used by the processor located on 300 to establish and maintain communications and thereby control of a flight formation under AFFCS. Typically, pilots and aircraft crew begin the AFFCS operation 310 by selecting the formation, entering the IFF and mission password. The AFFCS then creates a message packet to send to the other aircraft 320. The message packet is received and confirmed by the other aircraft 330, 340, etc. In the case of a rejection, the polling continues until acceptance or final rejection by the lead aircraft. The receipt of the message packet is then acknowledged in the processor and the autopilot engage command is sent to the autopilot and the formation is displayed 360. Feedback from each follower or controlled aircraft 370 is provided to the lead 300 for calculating turbulence dampening requirements for the formation. The mission profile is then flown in unison by all aircraft 380. Likewise all previous actions described in detail within these specifications are acted upon by the processor in a similar manner.

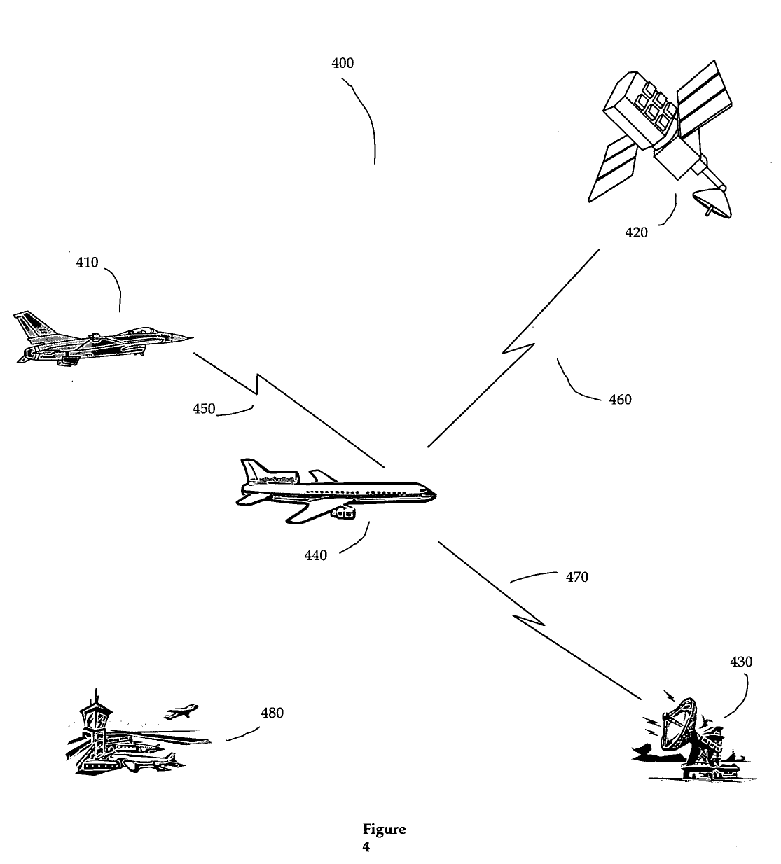

Referring to the embodiment in FIG. 4, Hijacking Intervention/Interdiction (400), each commercial aircraft has a discrete code that is known to the proper authorities. With this code and through the use of AFFCS functionality, either an aircraft or a ground control station with the appropriate equipment can take over control of an aircraft that has been hijacked in flight (440). An aircraft (410) with AFFCS engaged can enter the discrete encrypted code of the hijacked aircraft into their system to begin the process. This is transmitted to the hijacked aircraft (450). In order to prevent inadvertent control of aircraft a fail-safe has be designed into this procedure. A second discrete encrypted code confirming the request to assume control of an aircraft must come from a second source. This can be either a ground control station (430) or a satellite platform (420) that transmits the second encrypted code (460 or 470) to the aircraft that releases the control of the hijacked aircraft to the aircraft intercept leader (410) or a ground control station (430). The leader (410) can then initiate a mission profile that returns this aircraft flight of two to a military airbase (480) for final disposition of the hijacked aircraft and passengers.

In the foregoing specification, the invention has been described with reference to specific exemplary embodiments. However, one of ordinary skill in the art appreciates that various modifications and changes can be made without departing from the scope of the present invention as set forth in the claims below. Accordingly, the specification and figures are to be regarded in an illustrative rather than a restrictive sense and all such modifications are intended to be included within the scope of the present invention.

In addition, benefits, other advantages, and solutions to problems, and any element(s) what may cause any benefit, advantage, or solution to occur or become more pronounced are not to be construed as critical, required, or essential feature or element of any or all the claims. As used herein, the terms “comprises,” “Comprising,” or any other variation thereof are intended to cover non-exclusive inclusion, such that a process, method, article, or apparatus that comprises a list of elements does not include only those elements but may include other elements not expressly listed or inherent to such process, method, article, or apparatus.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

1. An integrated automatic formation flight control system for positive control of a first aircraft and a second aircraft, said system comprising:
a processor located on each aircraft, said processor being configured to compute a plurality of flight data including aircraft type, IFF code, TAS, IAS, position, winds aloft, RFP, FZ, altitude, weather, flight profile analysis, formation selection;
an aircraft communication bus capability, said communications bus being configured to exchange message/data packets;
a display located on each aircraft, said display being configured to change color of aircraft, show relative position and trends, identification, status;
an autopilot located on each aircraft, said autothrottle being configured to accept commands from the processor via the communications bus; and
a transceiver located on each aircraft, said transceiver being configured to transmit and receive encrypted message/data packets from each aircraft under AFFCS control.

2. The automatic flight control system according to claim 1, the processor being configured to take into consideration the velocity, direction, altitude of each aircraft in the formation.

3. The automatic flight control system according to claim 1, the processor being configured to compute a formation zone around each aircraft.

4. The automatic flight control system according to claim 1, the processor being configured to compute a relative formation point for each aircraft.

5. The automatic flight control system according to claim 2, the position to be latitude and longitude.

6. The automatic flight control system according to claim 5, the position to be computed using a global positioning system.

7. An integrated automatic formation flight control system for positive control of a first aircraft and a second aircraft, said system comprising:
a processor located on each aircraft, said processor being configured to compute a plurality of flight data including aircraft type, IFF code, TAS, IAS, position, winds aloft, RFP, FZ, altitude, weather, flight profile analysis, formation selection substantially providing separation and control for the formation;
an aircraft communication bus capability, said communications bus being configured to exchange message/data packets;
a display located on each aircraft, said display being configured to change color of aircraft, show relative position and trends, identification, status;
an autopilot located on each aircraft, said autothrottle being configured to accept commands from the processor via the communications bus; and
a transceiver located on each aircraft, said transceiver being configured to transmit and receive encrypted message/data packets from each aircraft under AFFCS control.

8. The automatic flight control system according to claim 7, said system capable of controlling multiple aircraft.

9. The automatic flight control system according to claim 7, said system being configured to utilize commands from either ground, satellite or airborne inputs.

10. The automatic flight control system according to claim 7, said system being configured to display multiple aircraft under formation control.

11. The automatic flight control system according to claim 7, said system being configured to access full cockpit control through discrete, encrypted identification.

12. A method of automatic formation flight control of multiple aircraft, some of which may be unpiloted, said method comprising of the acts of:
selection of formation;
calculating position, velocity, altitude, winds aloft, temperature and creation of data packets for communications;
repeatedly determining the previously stated calculations;
alerting via display changes to the formation;
communicating information between all aircraft in the formation; and
directing the mission flight plan.

13. The method according to claim 12, automatic formation flight control comprising a communication bus protocol and message/data packet structure.

14. The method according to claim 12, automatic formation flight control comprising an encrypted communications exchange between each aircraft in formation.

15. The method according to claim 12, automatic formation flight control comprising of stored formation patterns and the ability to select a pattern for a mission.

16. The method according to claim 12, automatic formation flight control comprising of inflight dampening algorithms with inputs coming from on-board sensors and historical storage.

17. The method according to claim 12, automatic formation flight control comprising of polling all aircraft in formation flight for positional information. Processor initiation of communications on a scheduled or exception basis.

18. The method according to claim 12, automatic formation flight control comprising of a computed formation zone with a buffer zone. A relative formation point is used to send positional data to each of the aircraft in the formation.

19. The method according to claim 12, automatic formation flight control comprising of a capability to provide flight guidance through processor interpretation of positional information and the communicating of autopilot and autothrottle changes to each aircraft.

20. The method according to claim 12, automatic formation flight control comprising of a capability to provide a intervention/interdiction of an aircraft that has been hijacked. Through the use of an aircraft or ground control station equipped with AFFCS to enter an encrypted code and then have it verified by a second source encrypted code (either satellite or ground station) to enable the control of the hijacked aircraft to be assumed by the intercepting aircraft or ground station and flown to a military base for conclusion of the event.
